(19) United States
(12) Patent Application Publication
(10) Pub. No.: US 2006/0043777 A1
(43) Pub. Date: Mar. 2, 2006

(54) Vehicle safety system with deployable lateral restraints

(76) Inventors: Keith Friedman, Santa Barbara, CA (US); Dennis Mihora, Santa Barbara, CA (US); Barry Demartini, Santa Barbara, CA (US)

Correspondence Address: MARK RODGERS, 1590 SAN ROQUE ROAD, SANTA BARBARA, CA, 93105, US

(21) Appl. No.: 10/916,564

(22) Filed: Aug. 12, 2004

(51) Int. Cl. B60N 2/42

(52) U.S. Cl. 297/216.13

(57) ABSTRACT

This invention is a vehicle safety system which provides lateral passenger restraint for certain accident events. The invention consist of lateral occupant restraints which are deployed in response to an indication that an appropriate event has occurred.

### RELATED APPLICATIONS

Not Applicable

### FEDERALLY SPONSORED RESEARCH

Not Applicable

### SEQUENCE LISTING

Not Applicable

### BACKGROUND OF THE INVENTION

The invention relates to vehicle safety, particularly for automobiles and light trucks, but is also applicable to heavy vehicles or aircraft. The system of this invention will provide increased occupant protection in the event of a rollover accident or side impact accident, or other situations where safety is enhanced by reducing lateral motion of the occupant.

Safety devices, such as side air curtains, are currently used in vehicles to prevent lateral occupant motion. However, current safety devices of this type are only positioned on the door or outboard side of the occupant, and tend to allow considerable lateral motion. For opposite side impacts, lateral restraint is highly desirable on the inboard side. Moreover lateral restraint on the outboard side that more closely connects the occupant to the structure of the vehicle has been shown to be effective.

Fixed lateral restraints have been proposed as comfort enhancing devices for high performance vehicles to keep occupants centered during high speed turns. However the need for lateral safety devices that automatically deploy before or during certain types of accidents is critical to achieving enhanced occupant protection. It has been shown that lateral restraints provide significant advantage for oblique impacts, up to nearly 90 degrees as the occupant is kept in a position where the safety belts and air restraints are effective. Without lateral restraint, the occupant rotates to the side such that the belt and airbag provide much less benefit. For impacts at angles greater than 90 degrees lateral restraints are effective at preventing the occupant from striking vehicle structures. Side restraints also bring the occupant to rest faster by providing a connection to the vehicle, dissipating the collision imparted velocities at the vehicle “ride down curve”, which often results in lower trauma impacts if the occupant does strike a part of the vehicle. In addition, for rollover accidents, lateral restraints will prevent the occupant form being ejected from the seat to the side. Despite the increased safety provided by lateral restraints, they have not been used to date because no one has solved the problems of incorporating effective safety restraints that still allow for normal operation of the vehicle, such as getting in and out of the seat. The current invention addresses the need for lateral occupant restraint in a manner that can be applied and used.

### BRIEF SUMMARY OF THE INVENTION

The invention is a safety system for a vehicle, consisting of a seat and at least one sensor for detecting a condition requiring deployment of safety devices. The invention uses at least one lateral restraint. In response to a signal from the sensor, a side restraint is deployed on at least one side of the seat to restrain the seat occupant from being displaced laterally.

In the preferred embodiment the lateral restraint is deployed by being rotated into position such that after deployment, the restraint serves as a side barrier. The restraint may also be deployed by being moved laterally until it is in contact or close proximity to the occupant. The restraint may also be positioned vertically to adjust for occupant size. The restraint may also be rotated, positioned laterally, and positioned vertically all in one implementation.

In one embodiment, the lateral restraint is rotated by a motor. In one version of this embodiment, the motor is used for occupant controlled adjustment of the lateral restraint position during normal operation for comfort, and automatically rotates to a safety position in response to the sensor signal. In another embodiment the lateral restraint is rotated by a spring rotator, such that the spring is released in response to the sensor signal. The spring loaded implementation also supports manual adjustment of the restraint position. In a further embodiment the lateral restraint is rotated by a pyro-technic device, such that the pyro is fired in response to the sensor signal.

Another embodiment contains a locking device to secure the lateral restraint in the safety position. In one version, a stop is inserted when the restraint reaches the desired point of rotation. In a further embodiment the sensor(s) communicates with smart safety system, and the action of the lateral restraints is controlled by the safety system. In another embodiment, the lateral restraint is partially deployed when the seat is occupied, and fully deployed in response to the sensor signal.

In one embodiment, the side restraint is unrolled in response to the sensor signal. In another, the lateral restraint is part of the seat, such the seat is pre-stressed to assume a shape with lateral restraint deployed. The seat is held in the non-deployed shape by a rigid internal structure, and the internal structure is rendered non rigid in response the sensor signal such that the seat assumes a shape with lateral restraints deployed.

In another embodiment the sensor signal is triggered by one or more of the following: a rollover condition, a side impact, an anticipatory event such as a side slip or a collision detection system signal, or the vehicle commencing operation. In one embodiment, the collision detection system is a radar collision detection system. In a further embodiment, if no collision results from the anticipatory event, the restraints are returned to their pre-event position.

### BRIEF DESCRIPTION OF THE DRAWINGS

The detailed description of how to make and use the invention will be facilitated by referring to the accompanying drawings.

FIG. 1 shows an exemplary seat with the restraints not deployed.

FIG. 2 shows the restraints after deployment

FIG. 3 shows a top view of the preferred embodiment.

FIG. 4 illustrates the operation of the lateral restraints.

FIG. 5 shows one embodiment of the invention

FIG. 6 shows another embodiment.

FIG. 7 shows a further embodiment

### DETAILED DESCRIPTION OF THE INVENTION

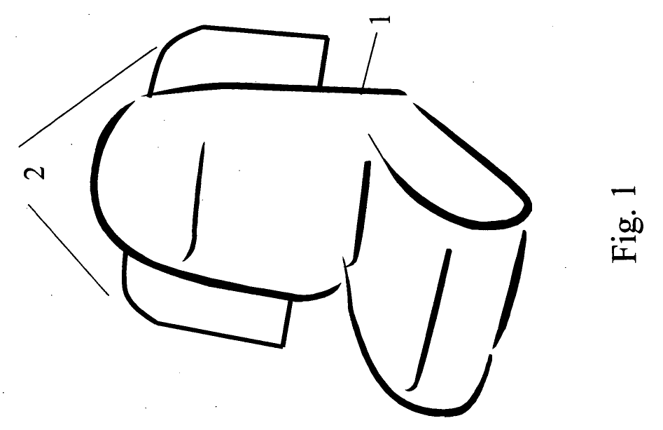

Referring to FIG. 1, a vehicle seat 1 is shown. This seat may be of a variety of designs known in the art. Shown also are two lateral restraints 2 which are depicted in a non-deployed position. Preferably, two restraints will be used, one on each side, although the invention applies equally to the case where only one restraint is used. The non-deployed position may be anywhere that the design of the vehicle allows for and is convenient to the occupant for non-accident conditions. Thus the restraints, for example, may be advantageously in a position that allows for easy entrance into the seat when not deployed.

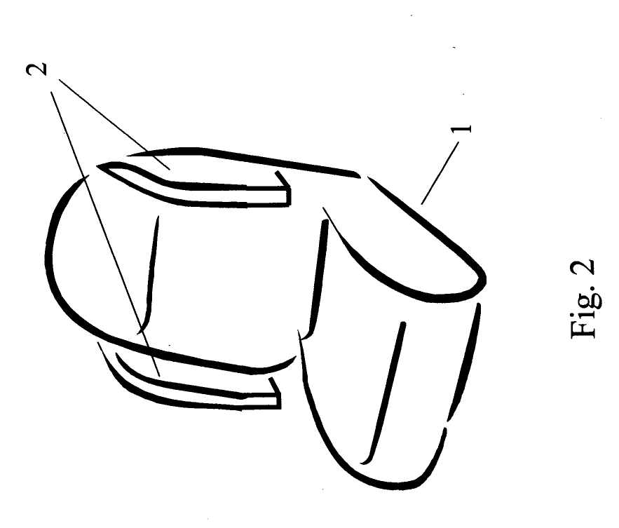

FIG. 2 shows the seat 1 with the restraints 2 deployed. The deployed position ideally should be such that the occupant is substantially prevented from moving laterally, but not such that the occupant is held too tight. The deployed position is shown at 90 degrees to the seat back. As will be described later, the actual deployed position is seat dependent. For vehicles with occupant sensing and intelligent safety systems, the restraints may be adaptable for different occupants.

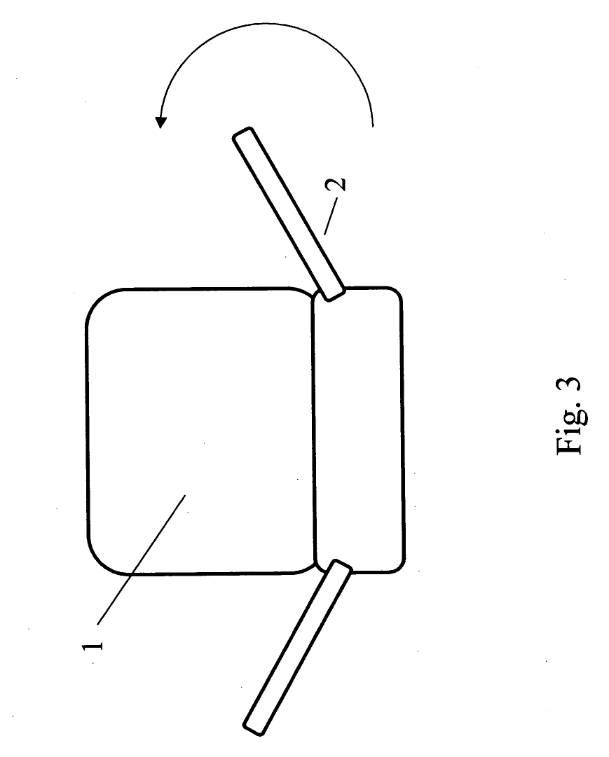

The detailed operation of the invention is as follows. Referring to FIG. 3, the side restraints 2 are shown as rotatable members. Other configurations are possible. For instance the side restraints could be arranged such that they moved forward from pockets or the side of the seat when deployed. However, the inventors feel that rotating toward the occupant is the safest way to deploy side restraints, and thus rotating members is the preferred implementation. The restraints, as shown in the figure, may be in a variety of deployed and non-deployed positions, within the scope of the invention. The exact deployed and non-deployed positions depend on vehicle design. It is important to understand that a design that allows for both a fully stowed and a fully deployed capability is the most complete implementation of the invention. However any implementation is desirable that allows the occupant access to the seat and the ability to operate the vehicle, but still provides a degree of lateral restraint in the event of an accident.

The invention includes a trigger to cause deployment of the restraints and a mechanism to accomplish the deployment. It is contemplated that the vehicle will have sensors that will sense different types of accident or operational events that would cause deployment. Applicable events include rollover, side impact, and oblique impact accidents. Side restraints on the window side, in conjunction with other rollover safety systems, would be highly beneficial in a rollover accident. The rollover sensor, either directly or through a smart safety system controller, would initiate the deployment of the restraints. Oblique and side impacts are much faster than rollover accidents, so it would be beneficial to begin deployment of a mechanical restraint as early as possible. Other possible trigger events include detection of a vehicle side slip, and collision detection, such as by radar. Such systems are increasingly available on vehicles. For an anticipatory deployment, it would be advantageous for the smart safety system to remember the predeployment position of the restraints, and in the event no accident takes place, return the restraints to the predeployed configuration. It is also possible to deploy the side restraints as soon as the seat is occupied, or the vehicle begins to move, at least to a useful extent. An alternative is to partially deploy the restraints when the seat is occupied, such that full deployment in an emergency situation requires less time.

Many materials and construction techniques for the restraints will be apparent to one skilled in the art. Conventional cushions, cushions that include airbags, or airbags alone are all possible choices. Structures that compress, including modern designs that compress with a substantially constant spring force are also suitable. The size and shape will vary with the seat design and available space.

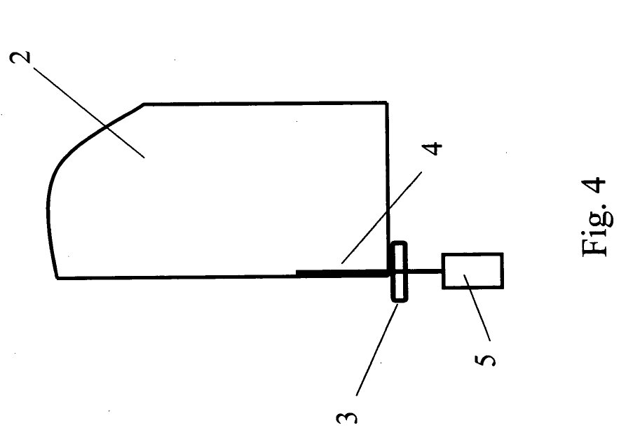

Referring to FIG. 4, the restraint 2 is connected by a coupling mechanism, 4, typically a rotatable shaft, to an actuator 5. Depending on the type of actuator, a locking mechanism 3 may be required to keep the restraint in the deployed position. Several different actuator types may be employed in the invention. One type of actuator is a motor. The sensor signal would trigger high speed rotation of the motor axis, which in turn rotates the restraint. The advantage of a motor actuator is that it also provides the possibility of powered user adjustment of the restraints during normal vehicle operation. The motor implementation would operate similarly to the invention described in co-pending application Ser. No. 10/807,325. Normal power adjustment of the restraints could operate at lower speed, while accident deployment would trigger a high power operation of the motor resulting in high speed rotation of the restraints. The motor implementation could support both a measured deployment rotation, with a device such as a rotary encoder, or rotate to a stop. Depending on the type of motor and coupling, the locking mechanism may not be required. The advantage of the motor implementation is straightforward compatibility with memory functions such as described above for anticipatory triggers, or simply to remember occupant characteristics. The occupant selected position of the lateral restraints could be remembered for each occupant along with the other occupant selected seat positions currently remembered by many existing powered seats.

A variety of spring actuators known in the art may be employed at 5. Spring actuators typically will require the locking mechanism 3. A locking mechanism could be as simple as spring loaded pin (or pins) that is released into a slot when the restraint reaches the point of desired rotation. Many suitable locking mechanisms will suggest themselves to one skilled in the art. Spring loaded implementations with locking mechanisms also lend themselves to user manual adjustment of the restraint position, similarly to the operation of manual reclining mechanisms. A pyro-technic mechanism similar to those employed in seat belt pretensioners may also be employed. The sensor signal triggers the pyro-technic piston which rolls up a cable or belt, attached to the shaft 4. The roll-up causes the restraint shaft to rotate. A pyro actuator will likely require a locking mechanism

In many vehicles, a smart safety controller may be employed. Such a system will accept the various sensor signals, such as the rollover sensor, and make decisions about safety device deployment depending on a variety of measured factors. Such factors are occupant presence, size, and weight. In such a system, the side restraint deployment may be modified according to the factors. For instance, for a large seat occupant, the amount of rotation of the restraints may be less than for a smaller occupant. For the implementation of the invention with motor actuators and encoders, fine control of restraint deployment could be easily achieved. Or, the restraints could have sensors built in to indicate when the restraint has contacted the occupant, or is close to the occupant, and cease rotation accordingly.

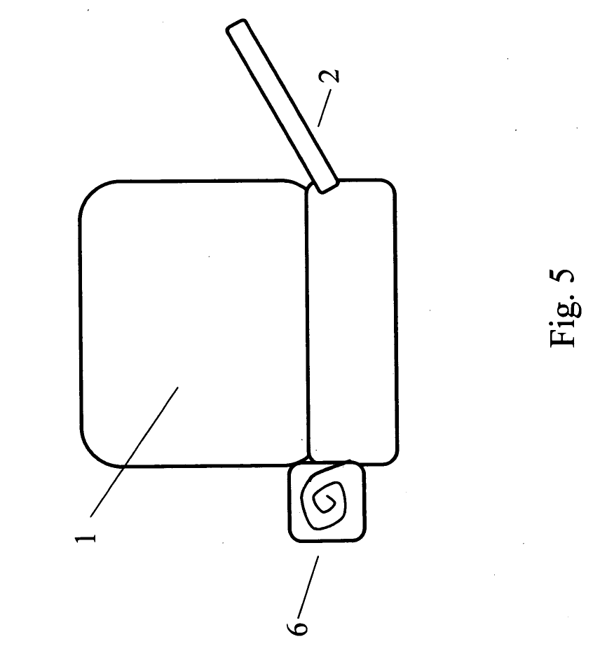

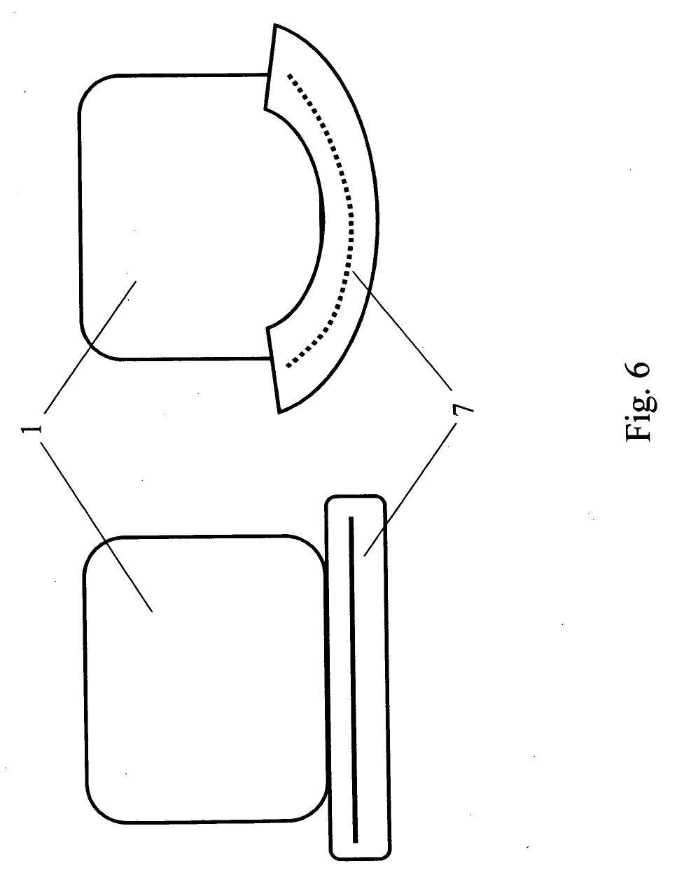

Other deployment mechanisms are contemplated as well. Referring to FIG. 5, the side restraint may be rolled up in the non-deployed position such that it is compact and out of the way, as shown at 6. When triggered, the restraint may be unfurled either with pressurized gas similar to airbags, or by releasing a spring unfurling mechanism. Another approach is shown in FIG. 6. The seat back may be constructed such that it is pre-stressed to have a natural shape that provides lateral restraint. The seat can be held in a conventional shape by a rigid structural support 7. The support 7 may be removed in an emergency situation which will allow the seat to assume the shape that includes lateral restraint. A variety of ways could be employed to remove the support, such as breaking it with a pyro charge triggered by a sensor signal.

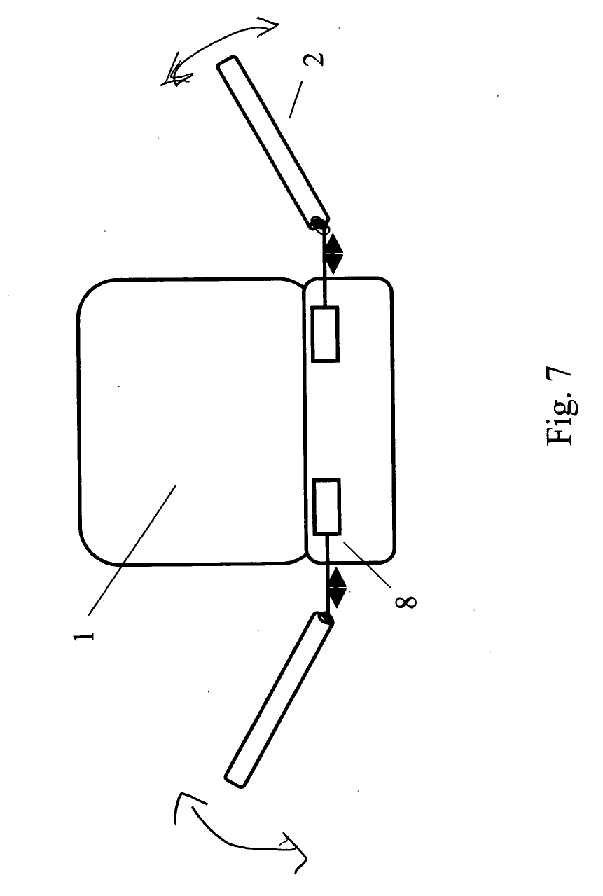

The inventors believe that providing even a less than optimal degree of lateral restraint will enhance safety. Thus the invention fully contemplates an implementation that allows for operator access to the seat and than deploys to a level consistent with operating the vehicle. The deployment could occur upon vehicle movement, seat belt fastening, sensing weight on seat, or other simple triggers. However, for vehicles with more complete safety systems and sensors, it is desirable to optimize the amount of lateral restraint for each occupant. As shown in FIG. 7, to truly optimize for a wide variety of vehicle sizes, it may be advantageous to adjust the restraints laterally as well as rotationally. Additional actuators 7 are shown which provide this additional adjustment. The most convenient implementation of actuator 7 is a motor driven screw. Other actuators will suggest themselves to one skilled in the art. The use of actuators 7 with appropriate sensing allow for the lateral restraint to be positioned at an optimum angle for a range of occupant sizes. During deployment the restraints could be moved inward until either contact or proximity to the occupant is sensed. Then the restraints could be rotated appropriately. Alternatively, although not optimum, particularly for the inboard side, the restraint could be always at the correct orientation, and simply moved in to the right position laterally. It also is advantageous to adjust the restraints vertically to accommodate different sized occupants. Thus another embodiment of the invention also includes vertical actuators. A preferred implementation of the vertical actuators is to use motors and occupant sensors to optimally position the restraints vertically for a particular occupant. Thus the invention my encompass rotational, lateral and vertical positioning of the restraints to best fit an occupant.

We claim:

1. a safety system for a vehicle, comprising:
a seat,
at least one sensor for detecting a condition requiring deployment of safety devices; and,
at least one lateral restraint wherein in response to a signal from the sensor, a side restraint is deployed on at least one side of the seat to reduce lateral displacement of the seat occupant.

2. The safety system of claim 1, wherein the lateral restraint is deployed by being rotated into position such that after deployment, the restraint serves as a side barrier.

3. The safety system of claim 2 wherein the lateral restraint is rotated by a motor.

4. The safety system of claim 3, wherein the motor is used for occupant controlled adjustment of the lateral restraint position during normal operation, and automatically rotates to a safety position in response to the sensor signal.

5. The safety system of claim 2 wherein the lateral restraint is rotated by spring rotator, such that the spring is released in response to the sensor signal.

6. The safety system of claim 2 wherein the lateral restraint is rotated by a pyro-technic actuator, such that the pyro-technic is fired in response to the sensor signal.

7. The safety system of claim 2 further comprising a locking device to secure the lateral restraint in the safety position.

8. The locking device of claim 7 wherein a stop is inserted when the restraint reaches the desired point of rotation.

9. The safety system of claim 1 wherein the sensor(s) communicates with smart safety system, and the action of the lateral restraints is controlled by the safety system.

10. The safety system of claim 1 wherein the lateral restraint is partially deployed when the seat is occupied, and fully deployed in response to the sensor signal.

11. The safety system of claim 1 wherein the side restraint is unrolled in response to the sensor signal.

12. The safety system of claim 1 wherein;
the lateral restraint is part of the seat,
the seat is pre-stressed to assume a shape with lateral restraint deployed,
the seat is held in the non-deployed shape by a rigid internal structure, and;
the internal structure is rendered non rigid in response to the sensor signal such that the seat assumes a shape with lateral restraints deployed.

13. The safety system of claim 1 wherein the sensor signal is triggered by at least one of;
a rollover condition,
a side or oblique impact,
a collision anticipatory event, or;
the vehicle commencing operation.

14. The safety system of claim 13 where the anticipatory event is a side slip.

15. The safety system of claim 14 where the anticipatory event is an approaching object detected by a collision detection system.

16. The safety system of claim 15 wherein the collision detection system is a radar collision detection system.

17. The safety system of claim 14 where if no collision results from the anticipatory event, the lateral restraints are returned to the position before deployment.

18. The safety system of claim 1 wherein deployment includes the lateral restraints being moved laterally until they contact or are in proximity to the occupant.

19. The safety system of claim 1 wherein deployment includes the lateral restraints being moved vertically to adjust for occupants of varying size.

20. The safety system of claim 5 wherein the lateral restraints may be manually adjusted by the user.
